(19) United States
(12) Patent Application Publication
(10) Pub. No.: US 2008/0029552 A1
(43) Pub. Date: Feb. 7, 2008

(54) DISPENSING CONTAINER FOR FLOWABLE MATERIALS

(76) Inventor: Jason Scott Apfel, WOODBURY, NY (US)

Correspondence Address: ELLIOT FURMAN, 15 WEST 81ST STREET #11J, NEW YORK, NY, 10024, US

(21) Appl. No.: 11/462,989

(22) Filed: Aug. 7, 2006

(51) Int. Cl. G01F 11/00; B65D 37/00

(52) U.S. Cl. 222/386; 222/206; 222/215

(57) ABSTRACT

The present invention discloses a container for dispensing substantially all of the flowable material in the container, including the material adhering to the inner walls of the container. The container comprises a main body having a hollow portion, a dispensing outlet, a slideable arrangement positioned within and in contact with the inner surface of the main body, an axial slot on the outer surface of the main body, and a tab connected to the slideable arrangement and extending outwardly through the axial slot, where movement of the tab causes displacement of the slideable arrangement axially within the main body, thereby dispensing the flowable material through said dispensing outlet. The container of the present invention, in various embodiments, may be of any shape or cross section such as cylindrical, extruded oval, oblong and ellipsoidal.

### FIELD OF THE INVENTION

The present invention relates to a container for dispensing flowable materials. More specifically, it relates to a container for dispensing substantially all of the flowable material in the container, including the material adhering to the inner walls of the container.

### BACKGROUND

Containers such as plastic and glass bottles are used to hold and dispense various products available to consumers. For example, shampoo, conditioner, and hair gel are typically sold in rigid, semi-rigid, or squeezable plastic bottles. Condiments such as ketchup, mustard, mayonnaise, and salad dressing are sold in squeezable plastic or solid glass bottles. Sunscreen lotion is sold in squeezable plastic bottles, while toothpaste is sold in squeezable plastic or rigid plastic bottles.

These containers or bottles have an opening on one end to dispense the product. The opening may be covered with a cap or some other lid to prevent the product from leaking when stored, and to preserve freshness. Depending on the design of the bottle, the bottle may be stored with the cap side up or the cap side down. When stored with the cap side down, the product collects toward the cap end of the bottle.

To dispense the product, the container is positioned with the opening pointing down and it is squeezed to force the product out of the opening, or the container is pointed down and gravity pulls the product out of the opening, or a combination of both.

One common frustration while dispensing the product occurs when there is only a small amount of product left in the container. The viscosity of the product can cause a substantial amount of the product to adhere to the walls of the container.

To dispense the last bit of product, a user must violently shake and squeeze the container to cause as much of the remaining product to collect at and be dispensed out of the opening. Yet, a substantial amount of product may remain stuck to the inner walls of the container.

Various developments have taken place, and attempts have been made to help mitigate this waste of product. For example, the container is designed so that it can be stored cap side down. Over time, this causes the product to accumulate towards the cap, down the interior walls of the container, thereby increasing the amount of product that can be dispensed. Nevertheless, a substantial amount of product may remain stuck within the container; the design is not sufficient to cause the product to be expelled from the container. Also, some containers cannot be practically designed to be stored cap side down. This may be the case for mechanical reason wherein stability of the container is important, and for marketing reason where the container must have a particular shape to accommodate a display space. And, the cap side down design does little good unless the container has been stored for an extended period of time, thereby allowing gravity to pull on the product and cause it to accumulate at the cap end.

Toothpaste manufacturers have also attempted to solve the product waste problem by enclosing the toothpaste in a container having a pump and having a cross-sectional shape that is substantially uniform throughout the length of the container, such as a cylinder, an opening for dispensing the toothpaste on one end, i.e., the cap end, and a movable plunger forming a seal on the other end. To dispense the toothpaste, the pump is pressed, forcing the toothpaste out of the opening, and causing the plunger to move up towards the cap end. Hair product manufacturers have also used similar container designs to solve the product waste problem.

Yet another container designed to solve the product waste problem is a container having a pump connected to a tube extending through the container and to the bottom of the container. For example, containers of moisturizing lotions and liquid soaps. To dispense the product, the pump is depressed drawing the product through the tube and out of the opening of the pump. In addition to product wasted because of adherence to the inner walls of the container, product is also wasted because the tube cannot extend completely to the container bottom to draw the last bit of product out.

Therefore, there is a need for a container with a mechanism for dispensing substantially all of the flow able material, including the material adhering to the inner walls of the container. Further, there is a need for the mechanism to work with a container having any shape or cross section.

### SUMMARY

A container for dispensing substantially all of the flowable material in the container, including the material adhering to the inner walls of the container is disclosed. The container of the present invention, in various embodiments, may be of any shape or cross section such as cylindrical, extruded oval, oblong and ellipsoidal.

In accordance with an embodiment, the present invention provides a container comprising a main body having a hollow portion, a dispensing outlet, a slideable arrangement positioned within and in contact with the inner surface of the main body, an axial slot on the outer surface of the main body, and a tab connected to the slideable arrangement and extending outwardly through the axial slot, where movement of the tab causes displacement of the slideable arrangement axially within the main body, thereby dispensing the flowable material through said dispensing outlet.

The slideable arrangement, in various embodiments, may either be a two piece member or single piece member. The slideable arrangement, in general, comprises a substantially rigid central portion positioned centrally in the hollow portion of the main body and a flexible outer portion extending substantially radially from the outer surface of the rigid central portion to the inner surface of the main body. The flexible outer portion may either be deformable or compressible. The rigid central portion is made of a rubber-like material while the flexible outer portion is made of a rubber-like or sponge-like material, depending upon its requirement to be either deformable or compressible. Also, the rigid central portion may include ridges that provide an enhanced sealing mechanism and as well enable in scraping more amount of the flowable material, which has adhered to the inner surface of the main body.

In accordance with another embodiment, the present invention provides a container similar to the container in the embodiment above. In this embodiment, the container additionally comprises a channel inwardly recessed from outer surface of the main body and centrally disposed along the axial slot. Also, the tab is retractable and comprises a handle portion extending outwardly through the axial slot. The handle portion can be retracted and stored in the channel when not in use, and extended from the channel when in use. The channel may include means for preventing movement of the tab such as notches.

The foregoing paragraphs have been provided by way of general introduction and should not be used to narrow the scope of the following claims. The embodiments will now be described with reference to the attached drawings.

### BRIEF DESCRIPTION OF THE DRAWINGS

FIG. 1 is a perspective view of a container in accordance with an embodiment of the present invention.

FIG. 2A is a perspective view of a slideable arrangement in accordance with an embodiment of the present invention.

FIG. 2B is a front view of the slideable arrangement shown in FIG. 2A.

FIG. 3A is a perspective view of the slideable arrangement in accordance with another embodiment of the present invention.

FIG. 3B is the front view of the slideable arrangement shown in FIG. 3A.

FIG. 4A is a perspective view of the slideable arrangement in accordance with another embodiment of the present invention.

FIG. 4B is a front view of the slideable arrangement shown in FIG. 4A.

FIG. 5A is a perspective view of a flexible outer portion of the slideable arrangement showing ridges.

FIG. 5B is a front view of the flexible outer portion shown in FIG. 5A.

FIG. 6A is a front view of the container showing a channel in accordance with another embodiment of the present invention.

FIG. 6B is a side view of the container shown in FIG. 6A.

FIG. 7A is an enlarged perspective view showing a tab and a plurality of notches in accordance with an embodiment of the present invention.

FIG. 7B is an enlarged front view showing the tab and the plurality of notches shown in FIG. 7A.

FIG. 8 is an illustration showing an axial slot with a seal in accordance with an embodiment of the present invention.

FIG. 9 is an enlarged view showing the axial slot with a sealing membrane in accordance with an embodiment of the present invention.

FIG. 10A is a side view of the container showing plurality of guides in accordance with another embodiment of the present invention.

FIG. 10B is a top view of the container shown in FIG. 10A.

FIG. 11A is a front view of the container having a non-uniform cross section in accordance with another embodiment of the present invention, showing a deformable slideable arrangement.

FIG. 11B is a side view of the container shown in FIG. 11A.

FIG. 12A is a front view of the container having a non-uniform cross section in accordance with another embodiment of the present invention, showing a compressible slideable arrangement.

FIG. 12B is a side view of the container shown in FIG. 12A.

### DETAILED DESCRIPTION

The present invention, in various embodiments, provides an improved container for dispensing substantially all of flowable materials in the container, including the flowable material adhering to inner walls of the container. The container of the present invention may be of any shape or cross section such as cylindrical, extruded oval, oblong and ellipsoidal. The container may be made up of a solid plastic, glass, flexible materials, or any other material. The flowable material may be highly viscous material such as toothpaste or highly fluid material such as shampoo.

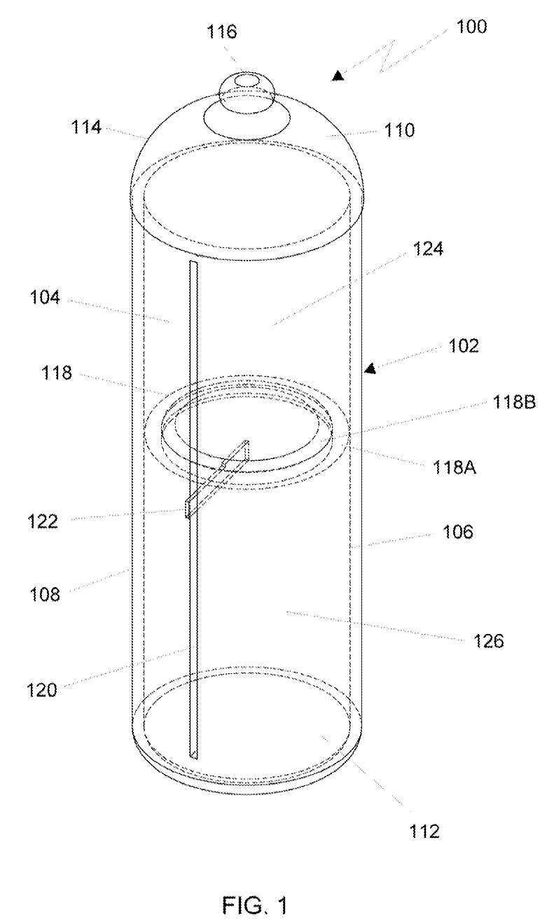

FIG. 1 shows a perspective view of the container in accordance with an embodiment of the present invention and is designated by the reference numeral 100. Container 100 comprises a main body 102 having a hollow portion 104, where main body 102 has an inner surface 106, an outer surface 108, a dispensing end 110 and a closed end 112. Dispensing end 110 includes a dispensing outlet 114 having an aperture 116 through which the flowable material is dispensed. The container further comprises a slideable arrangement 118 positioned within main body 102 and in contact with inner surface 106 of the main body, an axial slot 120 on outer surface 108 of the main body, extending substantially along the height of main body 102, and a tab 122 connected to slideable arrangement 118, extending outwardly through axial slot 120.

Main body 102 may be of any shape or cross section and is not limited to substantially uniform cross section as shown in FIG. 1. In this embodiment, main body 102 is shown and described herein as substantially cylindrical in shape or cross section. In one embodiment, dispensing outlet 114 is a separate component of the container and is secured to dispending end 110 of main body 102. Dispensing outlet 114 may be of different types such as screw-on, flip, and click open-click close. It will be understood, however, to those skilled in the art that, in various embodiments, dispensing outlet 114 may be an integral part of main body 102. Aperture 116, in various embodiments, may be covered with a cap or some form of lid (not shown) to prevent the flowable material from leaking and to preserve freshness.

Slideable arrangement 118 is movable axially within main body 102. It divides hollow portion 104 of the main body into a filled chamber 124 and an empty chamber 126. The filled chamber is toward dispensing end 110 and holds the flowable material. The slideable arrangement, in various embodiments, may either be a single piece member or a two piece member. In the embodiment shown in FIG. 1, slideable arrangement 118 is a two piece member.

Tab 122 connected to slideable arrangement 118 and extending outwardly through axial slot 120 is moveable substantially along the height of main body 102. The tab, in various embodiments, may either be a single piece member or a two piece member. In the embodiment shown in FIG. 1, tab 122 is a single piece member.

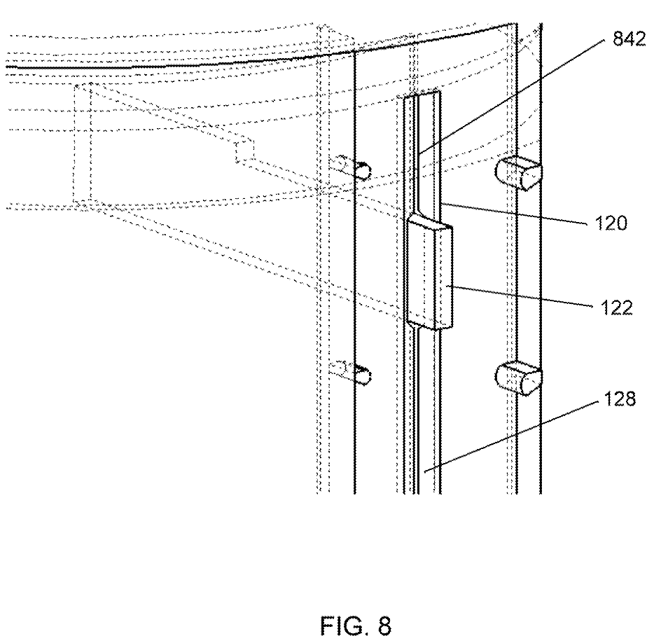

The container of the present invention, in various embodiments, further comprises an axial slot seal 128 (shown in FIG. 8 and described below) on outer surface 108 of main body 102 that provides sealing over axial slot 120 and the portion of tab 122 adjacent to inner surface 106 of main body 102.

In operation, the flowable material is filled in filled chamber 124 with slideable arrangement 118 and tab 122 positioned near to closed end 112 of main body 102. Closed end 112 of main body 102 ensures that any amount of the flowable material that escapes from filled chamber 124 to empty chamber 126 will safely and cleanly remain within the closed end. Tab 122 is moved in the direction of dispensing end 110, causing displacement of slideable arrangement 118 axially within main body 102. The movement of tab 122 and slideable arrangement 118 together causes the flowable material held in filled chamber 124, including the flowable material which is adhered to inner surface 106 of main body 102, to flow toward dispensing end 110 and dispenses the flowable material through aperture 116 present in dispensing outlet 114. Also, in one more embodiment, closed end 112 or a portion near the closed optionally includes a one way valve that allows air into empty chamber 126 when the slideable arrangement 118 is displaced.

It will be understood, to those skilled in the art that, the flowable material in the present invention may also be dispensed by other actions such as shaking or squeezing the container. Since such actions, by themselves, do not help in scraping and dispensing the flowable material adhering to inner surface 106 of main body 102, tab 122 may be moved, at any time, to cause adhering flowable material to be dispensed as well.

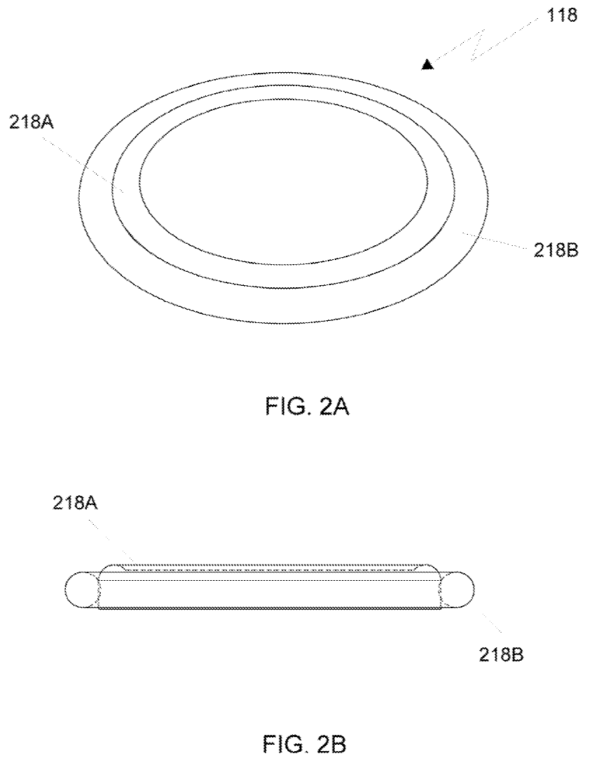

FIG. 2A shows a perspective view of the slideable arrangement according to the embodiment in FIG. 1. In this embodiment, slideable arrangement 118 is two piece member and is deformable. The slideable arrangement comprises a piston 218A positioned centrally in hollow portion 104 of main body 102 and a peripheral sealing member 218B connected to piston 218A. The piston is substantially rigid and solid and is made of a material such as, for example, rubber or plastic. Peripheral sealing member 218B may be connected to piston 218A, for example, using an adhesive or glue, or through thermal welding, or through pressurized fusing, or any other conventional attaching or fusing process.

The peripheral sealing member 218B, as shown in FIG. 2B, extends substantially radially from the outer surface of piston 218A to inner surface 106 of main body 102 and helps in preventing leakage of the flowable material from filled chamber 124 to empty chamber 126. Peripheral sealing member 218B is made up of a flexible and substantially non-porous material such as a rubber-like material or any other material possessing similar properties and characteristics. The rubber-like material, for example, may be foam, butyl, silicone, nitrile, neoprene, sponge rubber, polyurethane rubber, or polyacrylic rubber.

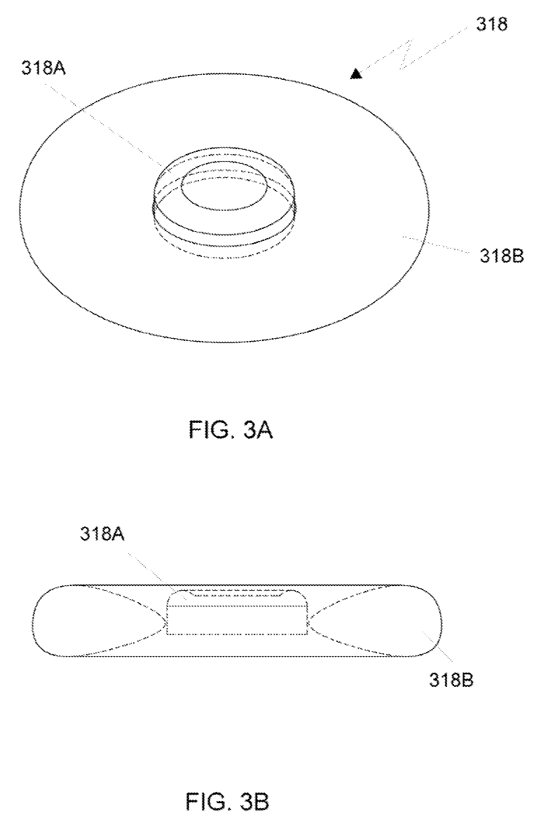

FIG. 3A shows a perspective view of the slideable arrangement according to another embodiment of the present invention. In this embodiment, slideable arrangement 318 is a two piece member and is compressible. Piston 318A is substantially rigid and solid and is made of a material such as, for example, rubber. Whereas, peripheral sealing member 318B is made of a, for example, sponge-like material so that slideable arrangement 318 can be moved to a narrow portion of the main body. FIG. 3B shows a front view of the slideable arrangement that is compressible.

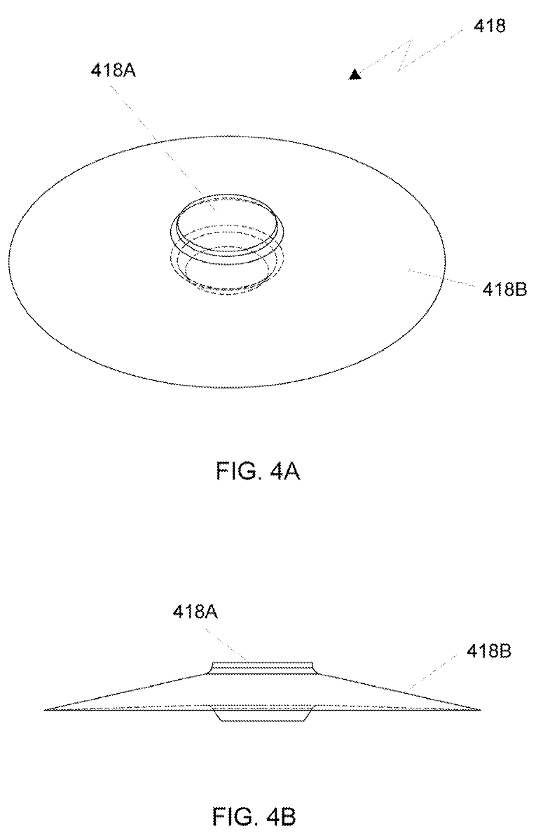

FIG. 4A shows a perspective view of the slideable arrangement in accordance with another embodiment of the present invention. In this embodiment, slideable arrangement 418 is a single piece member and is deformable. The slideable arrangement has a rigid central portion 418A and a flexible outer portion 418B. The rigid central portion, as shown in FIG. 4B, is positioned centrally in the hollow portion of the main body and is thicker than flexible outer portion 418B. The flexible outer portion extends substantially radially from rigid central portion 418A to the inner surface of the main body and helps in preventing leakage of the flowable material from the filled chamber to the empty chamber. Rigid central portion 418A and flexible outer portion 418B are made up of a rubber-like material or any other material possessing similar properties and characteristics. The rubber-like material, for example, may be foam, butyl, silicone, nitrile, neoprene, sponge rubber, polyurethane rubber, or polyacrylic rubber. Alternatively, the slideable arrangement may be compressible in nature and made of, for example, natural sponge, synthetic sponge, or any sponge-like material.

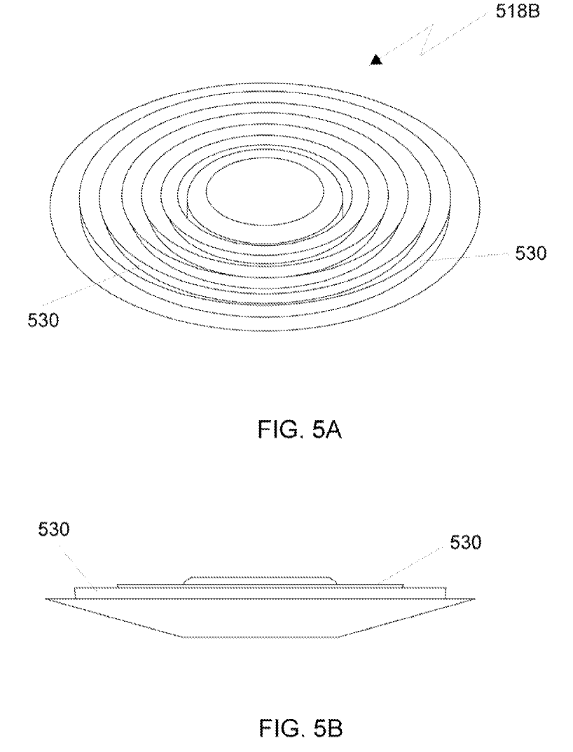

In one embodiment, as shown in FIGS. 5A and 5B, flexible outer portion 518B may have ridges 530. The ridges provide an enhanced sealing mechanism and also enable in scraping a greater amount of the flowable material, which has adhered to the inner surface of the main body.

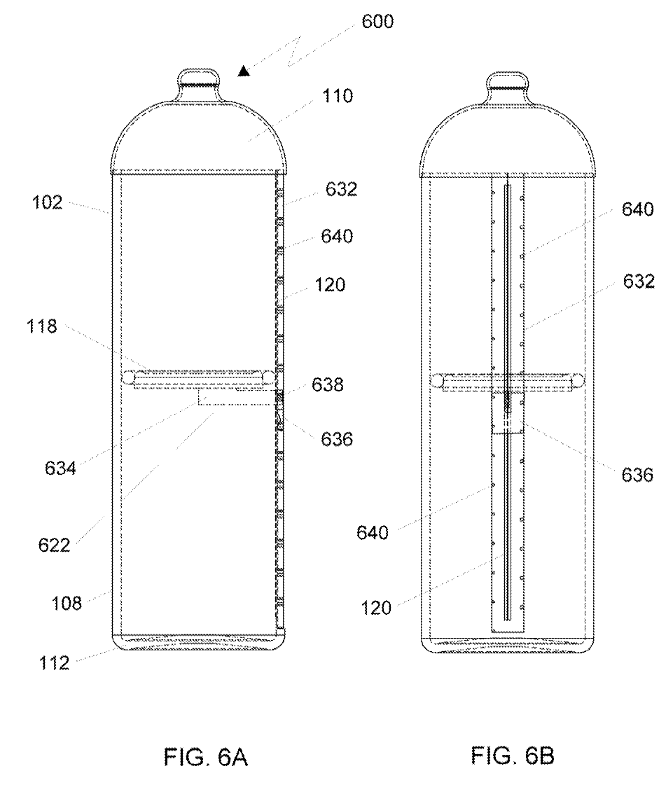

FIG. 6A shows a front view of the container in accordance with another embodiment of the present invention and is designated herewith by the reference numeral 600. Each of the components of container 600 described herein with respect to FIG. 6A correspond to the respective components of container 100 described above with respect to FIG. 1 except as denoted below. Container 600 additionally comprises a channel 632 inwardly recessed from outer surface 108 of main body 102 and centrally disposed along axial slot 120. Channel 632 has a width, which is greater than the width of axial slot 120, and extends substantially along the height of main body 102. In this embodiment, tab 622 is retractable and further comprises a web portion 634 connected to slideable arrangement 118, a handle portion 636 extending outwardly through axial slot 120, and a hinge 638 connecting the web portion and the handle portion. This way, handle portion 636 can be retracted and stored in channel 632 when not in use, and extended from channel 632 when in use. Handle portion 636, shown and described in various embodiments, is retracted and stored in channel 632 toward closed end 112 direction. Depending on the requirement, however, handle portion 636 may also be retracted and stored in channel 632 toward the direction of dispensing end 110.

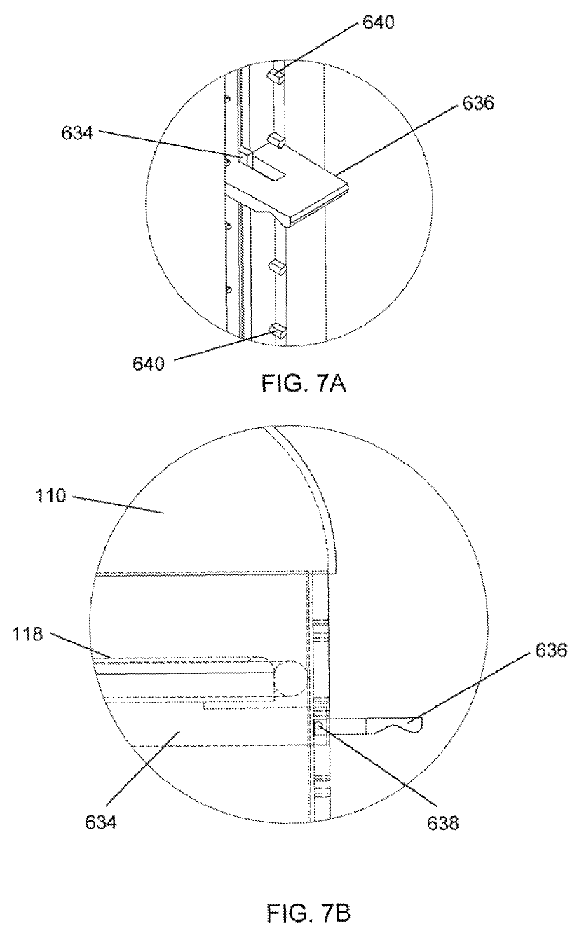

Channel 632 may also include a means for preventing movement of tab 622. This in turn prevents slideable arrangement 118 from sliding, unless external pressure is applied to tab 622. In this embodiment, the means for preventing movement of tab 622 comprises, for example, notches 640 as shown in FIG. 6B. As illustrated in FIGS. 7A and 7B, notches 640 prevent tab 622 from sliding. However, upon external pressure, tab 622 and notches 640 flex to allow tab 622 to slide.

FIG. 8 shows an illustration of axial slot 120 with axial slot seal 128 in accordance with the embodiment shown in FIG. 1. Axial slot seal 128 is preferably made of plastic or rubber and includes a slit 842 centered in axial slot 120 through which tab 122 extends outward. The axial slot seal acts as a barrier for the flowable material present in the filled chamber (not shown) and prevents any leakage of the flowable material through axial slot 120.

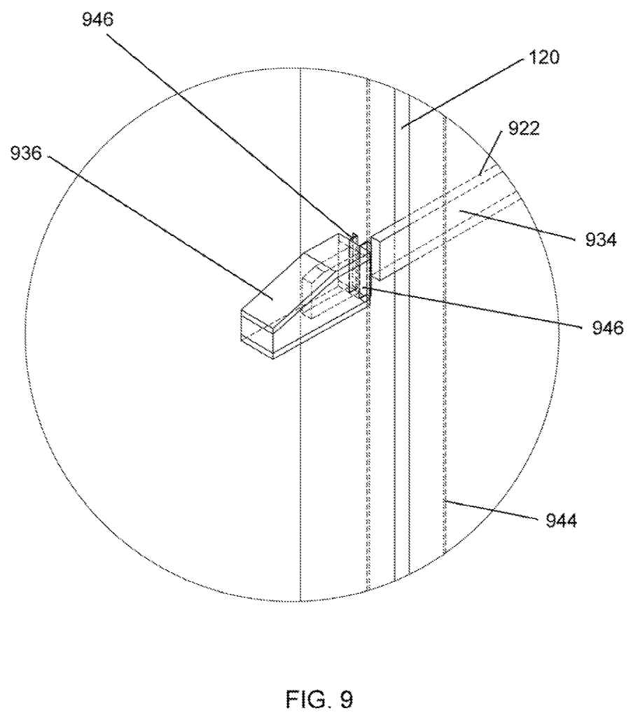

Alternatively in another embodiment, as illustrated in FIG. 9, a sealing membrane 944 over axial slot 120 is used. The sealing membrane is flexible and durable enough so as to conform or stretch, as tab 922 moves, without tearing. Sealing membrane 944 is preferably made of plastic or rubber and includes the slit (not shown) centered in axial slot 120 through which tab 922 extends outward. In another embodiment, sealing membrane 944 does not include a slit, and instead handle portion 936 is coupled to tab 922 with sealing membrane 944 situated between the two. In this embodiment, handle portion 936 remains in place and coupled with tab 922 via a channel in or around the axial slot 120, into which the handle is snapped into and slides. In this embodiment, handle portion slides in the channel in or around the axial slot, causing the tab to move, while the sealing membrane remains intact and merely flexes or conforms to any protrusions of the tab or handle.

The sealing membrane provides sealing over axial slot 120 and the portion of tab 922 adjacent to the inner surface of the main body. In this embodiment, tab 922 comprises web portion 934 connected to the slideable arrangement (not shown), handle portion 936 extending outwardly through axial slot 120 and having a pair of flanges 946 for retaining handle portion 936 with web portion 934.

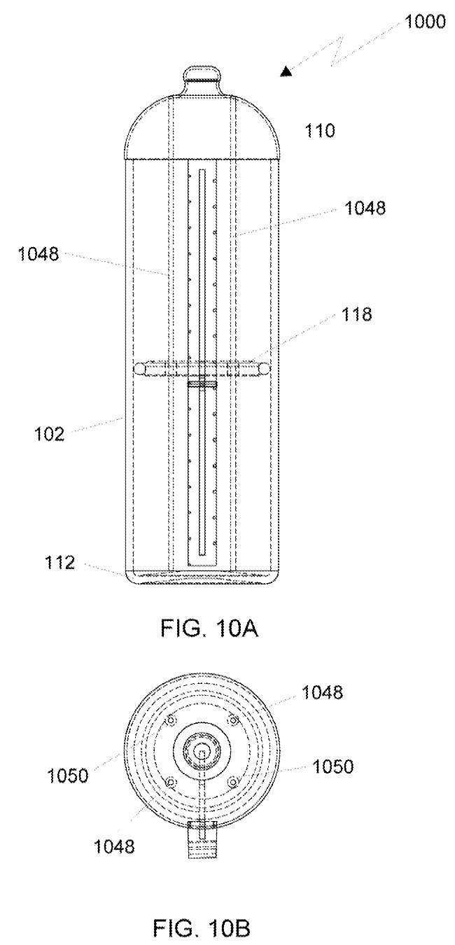

FIG. 10A shows a side view of the container in accordance with another embodiment of the present invention and is designated herewith by the reference numeral 1000. Each of the components of container 1000 described herein with respect to FIG. 10A correspond to the respective components of container 600 described above with respect to FIGS. 6A and 6B except as denoted below. Container 1000 additionally comprises a plurality of guides 1048 extending between dispensing end 110 and closed end 112 of main body 102 that provide support to slideable arrangement 118, and a plurality of apertures 1050 (seen in FIG. 10B) in the slideable arrangement through which plurality of guides 1048 pass. The plurality of guides adds stability to slideable arrangement 118 as it slides. A top view of container 1000 is shown in FIG. 10B. Other embodiments are possible, for example a single central guide, or the slideable arrangement may be made thicker so as to add stability.

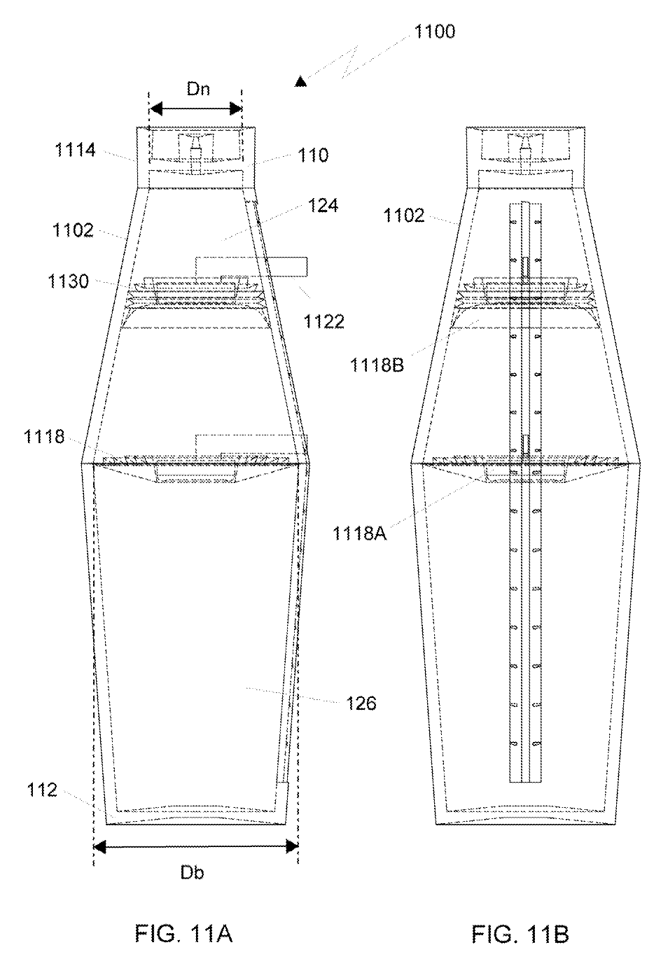

FIG. 11A shows a front view of the container in accordance with another embodiment of the present invention and is designated herewith by the reference numeral 1100. Each of the components of container 1100 described herein with respect to FIG. 11A correspond to the respective components of container 600 described above with respect to FIGS. 6A and 6B except as denoted below. Container 1100 comprises a main body 1102 having a non-uniform shape or cross section such as ellipsoidal, oblong, or the like. For example, main body 1102 may have a tapered neck and oblong cross section along at least some height of main body 1102. In this embodiment, dispensing outlet 1114 is an integral part of main body 1102 and slideable arrangement 1118 is deformable. Piston 1118A (seen in FIG. 11B) is substantially rigid and solid and made of a material such as, for example, rubber. Peripheral sealing member 1118B (seen in FIG. 11B) has ridges 1130 and conforms substantially to the interior shape or cross section of main body 1102. The peripheral sealing member is made up of a flexible and substantially non-porous material such as a rubber-like material or any other material possessing similar properties and characteristics. The rubber-like material, for example, may be foam, butyl, silicone, nitrile, neoprene, sponge rubber, polyurethane rubber, or polyacrylic rubber. FIG. 11B shows a side view of container 1100.

In FIGS. 11A and 11B, container 1100 with slideable arrangement 1118 in two different positions is shown. As can be seen, as tab 1122 is moved towards dispensing end 110 of the container, the peripheral sealing member is compressed to by greater degrees to conform substantially to interior shape or cross section of main body 1102. Although tab 1122 is same as tab 622, for the purpose of clarity, handle portion 1136 and hinge 1138 are not shown in FIGS. 11A and 11B.

In this embodiment, the diameter of piston 1118A is lesser than the smallest diameter of main body (designated herewith as “Dₙ”) 1102 and the diameter of peripheral sealing member 1118B is greater than or substantially equal to the largest diameter of main body (designated herewith as “D_{b}”) 1102. In this way, piston 1118A may extend fully into the narrowest part of the main body, and peripheral sealing member 1118B forms a seal with the main body substantially throughout the height of main body 1102 and prevents the flowable material from flowing from filled chamber 124 to empty chamber 126, respectively.

It will be understood to those skilled in the art that many variations to different components of container 1100 are possible and not limited to the one shown and described in this embodiment. For example, dispensing outlet 1114 may be a separate component of container 1100, slideable arrangement 1118 may be a single piece member with or without ridges 1130, and tab 1122 may be connected to slideable arrangement 1118 toward dispensing end 110 or toward closed end 112.

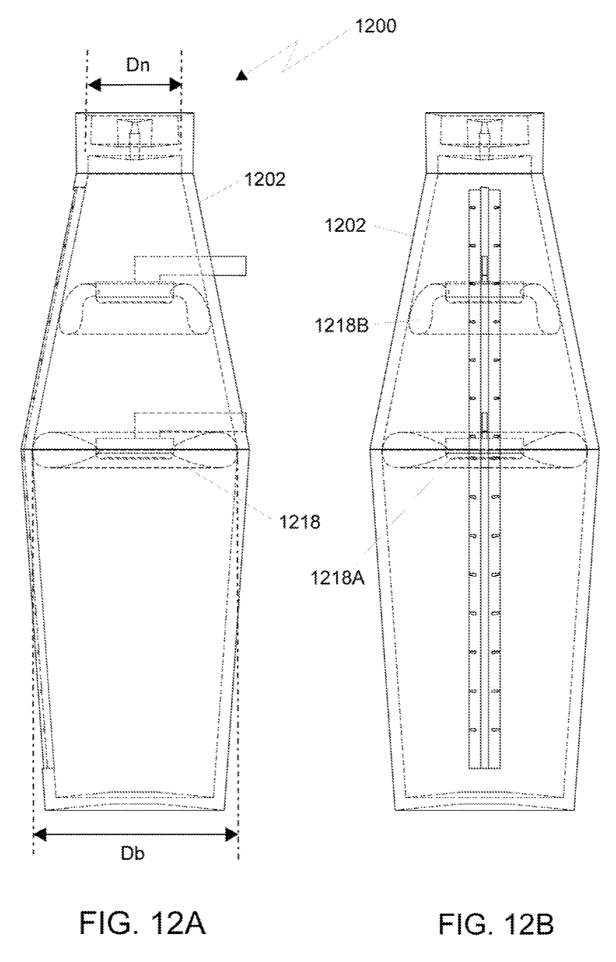

FIG. 12A shows a front view of the container similar to the embodiment shown in FIGS. 11A and 11B and is designated herewith by the reference numeral 1200. In this embodiment, slideable arrangement 1218 of container 1200 is compressible. Piston 1218A (seen in FIG. 12B) is substantially rigid and solid and made of a material such as, for example, rubber. Peripheral sealing member 1218B (seen in FIG. 12B) conforms substantially to the interior shape or cross section of main body 1202 and is made of, for example, a sponge-like material. FIG. 12B shows a side view of container 1200.

The present invention, in one embodiment, may also be adapted to work with pump containers. These pump containers introduced in the background section above have a pump connected to a tube extending through the container and to closed end of the container. In this embodiment, the tube is modified so that it is telescoping in nature, i.e., the tube is collapsible on itself. In this way, as the tab is pushed to move the slideable arrangement, the tube collapses while remaining in close contact with the slideable arrangement and enables in dispensing substantially all of the flowable material present in the container.

Various embodiments of the present invention as described above enable dispensing substantially all of the flowable material in a container, including the flowable material adhering to the inner surface of the container. The invention therefore helps in mitigating the problems associated with the wastage of the flowable material.

The foregoing detailed description has set forth a few of the many forms that this invention can take. It is intended that the foregoing detailed description be understood as an illustration of selected forms that the invention can take and not as a limitation to the definition of the invention. It is only the following claims, including all equivalents that are intended to define the scope of this invention.

What is claimed is:

1. A container for dispensing a flowable material, the container comprising:
a main body having a hollow portion, wherein the main body has an inner surface, an outer surface, a dispensing end, and a closed end, wherein said dispensing end has a dispensing outlet;
a slideable arrangement positioned within the main body and in contact with the inner surface of the main body, wherein the slideable arrangement divides the hollow portion of the main body into a filled chamber containing the flowable material and an empty chamber;
an axial slot on the outer surface of the main body, wherein the axial slot has a width and extends substantially along the height of the main body; and
a tab connected to the slideable arrangement and extending outwardly through the axial slot, wherein movement of the tab causes displacement of the slideable arrangement axially within the main body, thereby dispensing the flowable material through said dispensing outlet.

2. The container of claim 1 wherein the main body is of substantially uniform cross section.

3. The container of claim 1 wherein the main body is of substantially non-uniform cross section.

4. The container of claim 1 wherein the slideable arrangement comprises:
a piston positioned in the hollow portion of the main body, wherein the piston is substantially rigid and solid; and
a peripheral sealing member connected to the piston, wherein the peripheral sealing member extends substantially radially from the outer surface of the piston to the inner surface of the main body and prevents leakage of the flowable material from the filled chamber to the empty chamber, wherein the peripheral sealing member is flexible and substantially non-porous.

5. The container of claim 4 wherein the diameter of the piston is lesser than the smallest diameter of the main body and the diameter of the peripheral sealing member is greater than or substantially equal to the largest diameter of the main body.

6. The container of claim 4 wherein the peripheral sealing member comprises a rubber-like material.

7. The container of claim 6 wherein the rubber-like material is selected from a group consisting of foam, butyl, silicone, nitrile, neoprene, sponge rubber, polyurethane rubber and polyacrylic rubber.

8. The container of claim 4 wherein the peripheral sealing member comprises a sponge-like material.

9. The container of claim 1 wherein the slideable arrangement is a single piece member having a rigid central portion and a flexible outer portion, wherein the rigid central portion is positioned in the hollow portion of the main body.

10. The container of claim 9 wherein the diameter of the rigid central portion is lesser than the smallest diameter of the main body and the diameter of the flexible outer portion is greater than or substantially equal to the largest diameter of the main body.

11. The container of claim 9 wherein the rigid central portion comprises a rubber-like material and the flexible outer portion comprises a rubber-like material.

12. The container of claim 11 wherein the rubber-like material is selected from a group consisting of foam, butyl, silicone, nitrile, neoprene, sponge rubber, polyurethane rubber and polyacrylic rubber.

13. The container of claim 9 wherein the rigid central portion comprises a rubber-like material and the flexible outer portion is made up of a sponge-like material.

14. The container of claim 1 further comprising an axial slot seal.

15. The container of claim 14 wherein the axial slot seal comprises a material selected from a group consisting of plastic and rubber.

16. The container of claim 1 further comprising a sealing membrane over the axial slot.

17. The container of claim 1 further comprising a channel inwardly recessed from the outer surface of the main body and centrally disposed along the axial slot, wherein the channel has a width and extends substantially along the height of the main body, wherein the width of the channel is greater than the width of the axial slot.

18. The container of claim 17 wherein the channel includes means for preventing movement of the tab.

19. The container of claim 18 wherein the means for preventing movement of the tab comprises notches.

20. The container of claim 18 wherein the tab further comprising:
a web portion connected to the slideable arrangement;
a handle portion extending outwardly through the axial slot; wherein the handle portion is stored in the channel when not in use; and
a hinge connecting the web portion and the handle portion.

21. The container of claim 18 wherein the tab further comprising:
a web portion connected to the slideable arrangement; and
a handle portion extending outwardly through the axial slot; the handle portion comprising a pair of flanges for retaining the web portion with the handle portion.

22. The container of claim 1 further comprising:
at least one guide extending between said dispensing end and the closed end of the main body that provide support to the slideable arrangement; and
at least one aperture in the slideable arrangement through which the at least one guide passes.

23. The container of claim 1 wherein the main body comprises plastic.

24. The container of claim 1 wherein the main body comprises glass.

25. The container of claim 1 wherein the main body comprises a flexible material, thereby allowing squeezing of the main body.
